(19) United States
(12) Patent Application Publication
(10) Pub. No.: US 2024/0141723 A1
(43) Pub. Date: May 2, 2024

(54) SIMPLY-MOUNTED ROPE-RUNNING CURTAIN

(71) Applicant: NINGBO LIYANG NEW MATERIAL COMPANY LIMITED, Ningbo (CN)

(72) Inventors: Baoguo TAN, Ningbo (CN); Jianhong WEI, Ningbo (CN)

(21) Appl. No.: 18/383,719

(22) Filed: Oct. 25, 2023

(30) Foreign Application Priority Data
Oct. 31, 2022 (CN) 202222918057.2

(51) Int. Cl. E06B 9/324

(52) U.S. Cl. CPC E06B 9/324; E06B 9/262

(57) ABSTRACT

A simply-mounted rope-running curtain is provided comprising an upper mounting portion, a curtain body, at least one pull rope, a lower pull rod, at least one rope clamp, and at least one rope fixing device; an upper end of the curtain body is connected to the upper mounting portion and a lower end of the curtain body is connected to the lower pull rod; the pull rope runs through the upper mounting portion, the curtain body and the lower pull rod; the lower end of the curtain body and the lower pull rod slide up and down along the pull rope; the rope clamp is disposed on the lower pull rod to tightly clamp the pull rope and limit the lower pull rod; the rope fixing device is fixedly disposed below the lower pull rod to fix the free end of the pull rope exposed below the lower pull rod.

This application is based upon and claims priority to Chinese Patent Application No. 202222918057.2, filed on Oct. 31, 2022, the entire contents of which are incorporated herein by reference.

### TECHNICAL FIELD

The present disclosure relates to the field of curtain technologies, and in particular to a simply-mounted rope-running curtain.

### BACKGROUND

A simple curtain usually comprises a curtain body, a pull rope, an adhesive layer and a lower pull rod. An upper end of the curtain body is connected to the adhesive layer and a lower end of the curtain body is connected to the lower pull rod. The pull rope penetrates through the adhesive layer, the curtain body and the lower pull rod. A rope clamp for fixing the pull rope is disposed on the lower pull rod. By pulling the lower pull rod, the lower end of the curtain body can be slid up and down along the pull rope so as to open and close the curtain. The lower end of the curtain body naturally droops down along with the lower pull rod, and the upper end of the curtain body is bonded to the top of a window frame by using the adhesive layer, so as to achieve the mounting operation. The mounting structure is very simple, and the assembled parts are also less and the costs are lower, and therefore, it is very popular among consumers. The curtain bodies are mostly honeycomb curtain bodies or shutter curtain bodies. Since such curtain bodies have a resilience, these curtain bodies in natural state can only block a limited area of light. Further, the lower pull rod and the lower end of the curtain bodies may swing along with wind, easily scratching the area around the window frame. Also, people need to use their both hands to open or close the curtain, that is, one hand pulls the exposed pull rope and the other hand pulls the lower pull rod to move along the pull rope. Thus, the operation cannot be carried out with single hand.

### SUMMARY

In order to address the technical problems in the prior arts, the present disclosure provides a simply-mounted rope-running curtain, so as to open or close the curtain with single hand, while a lower end of a curtain body does not swing along with wind to avoid scratching a window frame, so as to obtain a larger unfolding area and achieve better light-blocking effect.

In order to address the above technical problems, the following technical solution is adopted: there is provided a simply-mounted rope-running curtain, which comprises an upper mounting portion, a curtain body, at least one pull rope, a lower pull rod, at least one rope clamp, and at least one rope fixing device. An upper end of the curtain body is connected to the upper mounting portion and a lower end of the curtain body is connected to the lower pull rod. The pull rope runs through the upper mounting portion, the curtain body and the lower pull rod. The lower end of the curtain body and the lower pull rod slide up and down along the pull rope. The rope clamp is disposed on the lower pull rod to tightly clamp the pull rope and hence limit the lower pull rod. The rope fixing device is fixedly disposed below the lower pull rod to fix the free end of the pull rope exposed below the lower pull rod.

Furthermore, there is one pull rope, one rope clamp and one rope fixing device. The pull rope runs through the upper mounting portion, the curtain body and the lower pull rod to form a rectangle. Both ends of the pull rope run through the rope clamp and are fixed by the rope fixing device. The rope clamp is fixed at a middle position of the lower pull rod, and the rope fixing device is fixed exactly below the rope clamp.

Furthermore, there are two pull ropes, one rope clamp, and one rope fixing device. The two pull ropes run through the upper mounting portion, the curtain body and the lower pull rod in a left-right symmetric way. The upper ends of the two pull ropes are fixed to the upper mounting portion, and the lower ends of the two pull ropes both run through the rope clamp and are fixed by the rope fixing device. The rope clamp is fixed at a middle position of the lower pull rod, and the rope fixing device is fixed exactly below the rope clamp.

Furthermore, there are two pull ropes, two rope clamps and two rope fixing devices. The two pull ropes run through the upper mounting portion, the curtain body and the lower pull rod in a left-right symmetric way. The upper ends of the two pull ropes are fixed to the upper mounting portion, and the lower ends of the two pull ropes both run through the corresponding rope clamps respectively and are fixed by the corresponding rope fixing devices. The two rope clamps are symmetrically fixed on the lower pull rod, and the two rope fixing devices are fixed exactly below the corresponding rope clamps.

Furthermore, the rope fixing device is fixed a wall surface below the window frame, and symmetrical rope-winding portions are disposed on the rope fixing device.

Furthermore, a rope-running groove is formed between the rope-winding portions on the rope fixing device, and a width of a groove mouth of the rope-winding groove is less than a diameter of the pull rope.

Furthermore, the upper mounting portion is an adhesive layer.

Furthermore, auxiliary rods are slidably connected at both ends of the lower pull rod.

Furthermore, the rope clamp comprises a mounting seat, a squeeze piece, and an elastic piece. The mounting seat is embedded onto the lower pull rod. The squeeze piece is provided with opposed first end and second end. The first end of the squeeze piece is slidably connected inside the mounting seat. A first chamber for slidably connecting the squeeze piece is disposed inside the mounting seat, and the second end of the squeeze piece is exposed outside the mounting seat. The elastic piece is disposed inside the first chamber. One end of the elastic piece is abutted against the mounting seat and the other end is abutted against the first end of the squeeze piece. A first rope-running hole is disposed on the mounting seat, and a second rope-running hole is disposed on the squeeze piece. In natural state, the elastic piece squeezes the mounting seat and the squeeze piece in opposite directions, such that the first rope-running hole and the second rope-running hole are staggered to clamp the pull rope. The second end of the squeeze piece is provided with a force receiving surface for a finger to press. When a finger presses the force receiving surface, the elastic piece is compressed, such that the first rope-running hole and the second rope-running hole are overlapped to unlock the pull rope.

Furthermore, the opening direction of the first chamber is perpendicular to the length direction of the lower pull rod, and is same as the width direction of the lower pull rod. The force receiving surface on the squeeze piece is exposed outside the lower pull rod. Stop blocks are symmetrically disposed at both sides of an opening end of the first chamber. Catching blocks matching the stop blocks are disposed at both sides of the first end of the squeeze piece.

Compared with the prior arts, the present disclosure has the following advantages: in the present disclosure, with disposal of the rope fixing device below the curtain to fix the free end of the pull rope, a user can open or close the curtain with one hand, while the other hand is freed from pulling the pull rope. Since an upper end of the pull rope is fixed to the top of a window frame along with the upper mounting portion and the free end of the pull rope is fixed below the window frame via the rope fixing device, the pull rope is tensioned to form a fixed rope rail. Thus, the curtain body can slide up and down along the pull rope and the user can push and pull the lower pull rod with single hand to drive the curtain body to slide up and down along the pull rope. Further, the lower pull rod can stay at any position of the pull rope by using the rope clamp, bringing convenience to use. In addition, the tensioned pull rope will not swing along with wind so as to limit the lower end of the curtain body from freely swinging, and the curtain body has to move up and down along the pull rope. Therefore, the curtain body will not scratch the articles around the window frame during the use of the curtain. Furthermore, since the free end of the pull rope is fixed below the window frame by using the rope fixing device, the light-blocking area of the curtain body is increased. Originally, the lower end of the curtain body in natural state may retract together with the pull rope toward the upper mounting portion due to the resilience of the curtain body. For example, if the lower end of the curtain body is pulled down one meter, the lower end of the curtain body will rebound 0.1 meters once released, which means that the lower end of the curtain body is actually pulled down 0.9 meters. But, in the present disclosure, when the free end of the pull rope is fixed by using the rope fixing device, after the lower end of the curtain body is pulled down one meter, the rope clamp may stop at the instantaneous position without any rebound. Therefore, its unfolding area is an area that it is actually pulled open, making the light-blocking area larger and more accurate. After the pull rope is fixed by the rope fixing device, the pull rope will not retract upward due to the rebound of the curtain body. Overcoming the resilience of the curtain body, the pull rope enables the curtain body to stop at any instantaneous position, bringing better use experiences.

### BRIEF DESCRIPTION OF THE DRAWINGS

In order to describe the embodiments of the present invention or the technical solution of the prior art more clearly, brief descriptions will be made below to the accompanying drawings involved in descriptions of the embodiments or the prior art. Obviously, the accompanying drawings are merely illustrative, and other drawings may also be obtained by those skilled in the art based on these drawings without paying creative work.

The structures, scales, sizes and the like depicted in the specification are only used by those skilled in the art to know and read the contents disclosed by the specification rather than to limit the embodiments of the present disclosure. Therefore, the structures, scales, sizes and the like do not have technically substantive meanings. Any modification, changes or adjustment to the structures, the scales and sizes shall all fall within the scope of protection covered by the technical contents disclosed by the present invention without affecting the effects and the purposes achieved by the present invention.

FIG. 1 is a structural schematic diagram of an embodiment of the present disclosure.

FIG. 2 is a structural schematic diagram of another embodiment of the present disclosure.

FIG. 3 is a structural schematic diagram of another embodiment of the present disclosure.

FIG. 4 is structural schematic diagram of a rope fixing device according to the present disclosure.

FIG. 5 is a top view of a rope fixing device according to the present disclosure.

FIG. 6 is a structural schematic diagram illustrating cooperation between a lower pull rod and auxiliary rods according to the present disclosure.

FIG. 7 is a structural schematic diagram illustrating cooperation between a lower pull rod and a rope clamp according to the present disclosure.

FIG. 8 is a structural schematic diagram illustrating a rope clamp according to the present disclosure.

FIG. 9 is an exploded view of a rope clamp according to the present disclosure.

FIG. 10 is a transverse sectional view of a rope clamp according to the present disclosure.

FIG. 11 is a longitudinal sectional view of a rope clamp according to the present disclosure.

FIG. 12 is a structural schematic diagram illustrating a squeeze piece according to the present disclosure.

The numerals of the drawings are described below: 1. upper mounting portion, 2. curtain body, 3. pull rope, 4. lower pull rod, 5. rope clamp, 5.1 mounting seat, 5.1.1 first rope-running hole, 5.1.2 first chamber, 5.1.3 second chamber, 5.1.4 stop block, 5.1.5 positioning rib, 5.2 squeeze piece, 5.2.1 first end, 5.2.2 second end, 5.2.3 second rope-running hole, 5.2.4 force receiving surface, 5.2.5 protrusion column, 5.2.6 catching block, 5.2.7 partition groove, 5.3 elastic piece, 6. rope fixing device, 6.1 rope-winding portion, 6.2 rope-running groove, 6.3 groove mouth, 7. auxiliary rod, 8. window frame.

### DETAILED DESCRIPTIONS OF EMBODIMENTS

The present invention will be further detailed below in combination with specific embodiments.

In the descriptions of the present invention, it is understood that orientation or positional relationship indicated by the terms such as “central”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, “axial”, “radial”, and “circumferential” is used only for ease of descriptions and simplification of descriptions and does not indicate or imply that the indicated devices or elements must have a particular orientation, or be constructed or operated in a particular orientation. Therefore, such terms shall not be understood as limiting of the present invention.

Further, the terms “first” and “second” are used for descriptions only and shall not be understood as indicating or implying relative importance or implicitly indicating the number of the indicated features. As a result, the features defined by “first” and “second” may explicitly or implicitly include at least one feature. In the descriptions of the present invention, the meaning of “several” refers to at least two, for example, two or three or the like, unless otherwise clearly stated.

In the present invention, unless otherwise clearly stated or defined, the terms “mount”, “connect”, “couple”, and “fix” and the like shall be understood in a broad sense, for example, may be fixed connection, or detachable connection, or formed into one piece; or may be mechanical connection, or electrical connection; or direct connection or indirect connection through an intermediate medium, or may be internal communication between two elements or mutual interaction of two elements, unless otherwise stated. Those skilled in the art may understand the specific meanings of the above terms in the present invention according to actual situations.

In the present invention, unless otherwise clearly stated or defined, the first feature being “on” or “below” the second feature refers to that the first feature and the second feature are in direct contact, or the first feature and the second feature are in indirect contact through an intermediate medium. Furthermore, the first feature being “above” or “on” the second feature refers to that the first feature is exactly above or obliquely above the second feature, or only refers to that the first feature has a higher horizontal height than the second feature. The first feature being “under” or “below” the second feature refers to that the first feature is exactly under or obliquely below the second feature, or only refers to that the first feature has a smaller horizontal height than the second feature.

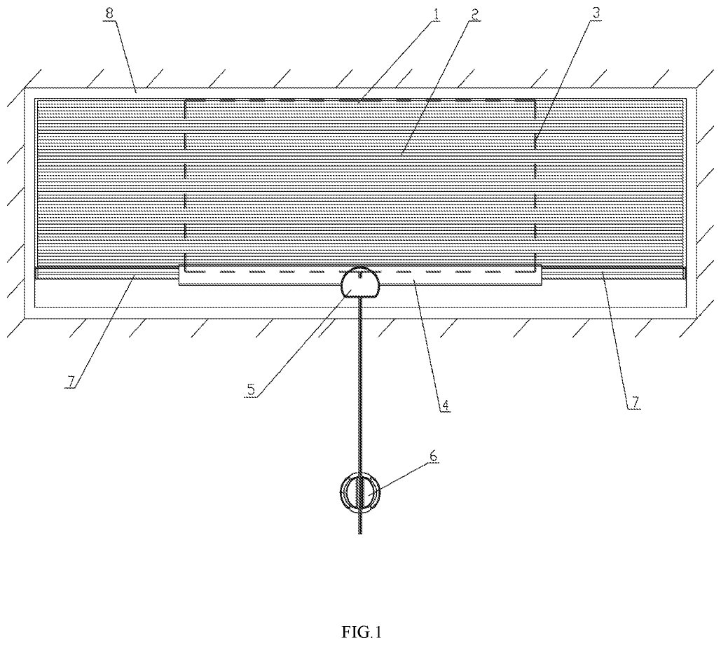

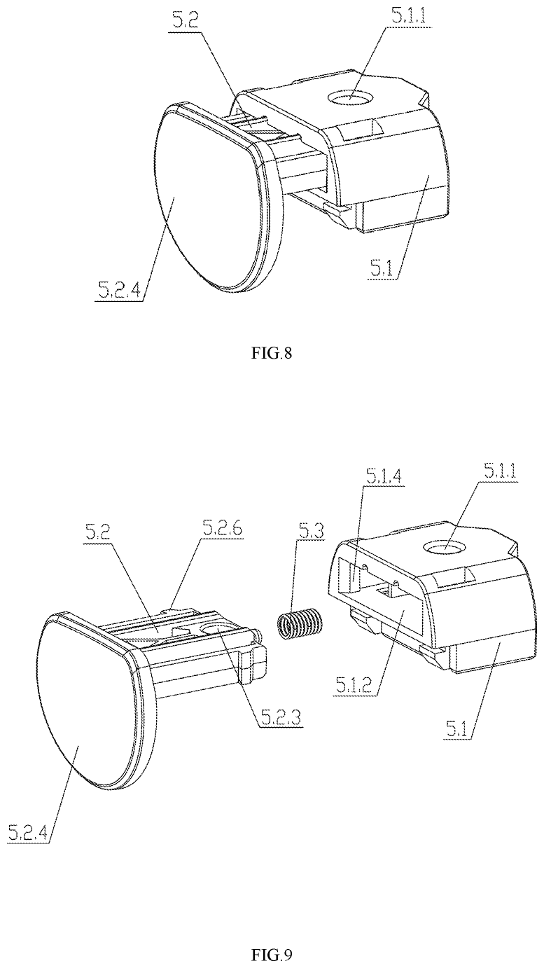

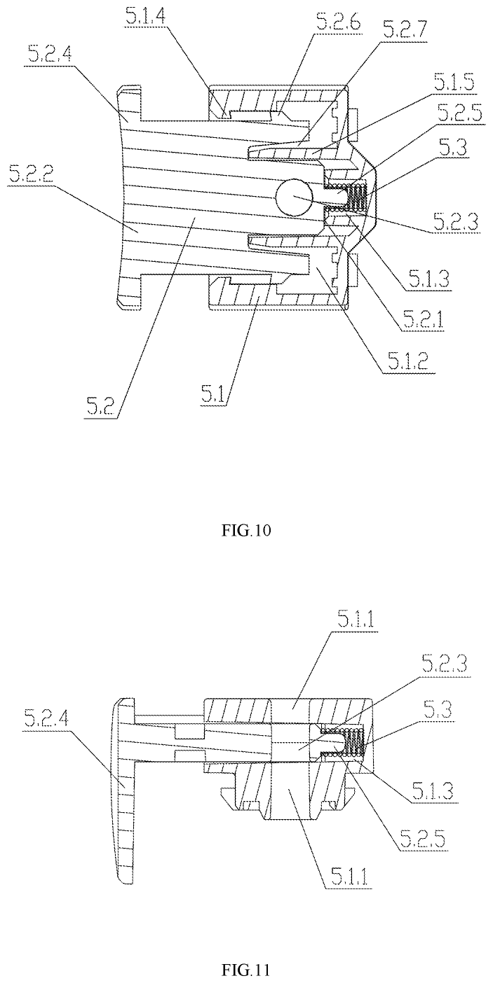

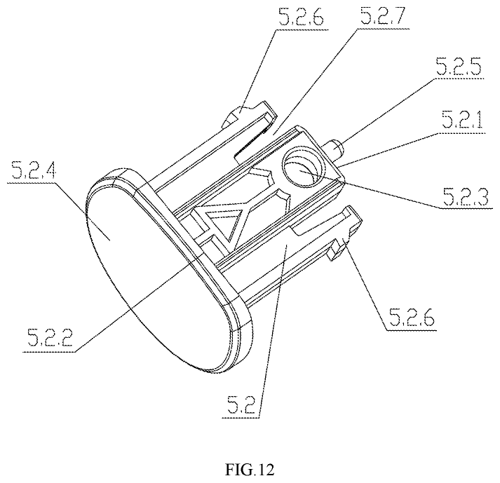

As shown in FIGS. 1 to 12, the present disclosure provides a simply-mounted rope-running curtain, which comprises an upper mounting portion 1, a curtain body 2, at least one pull rope 3, a lower pull rod 4, at least one rope clamp 5, and at least one rope fixing device 6. An upper end of the curtain body 2 is connected to the upper mounting portion 1 and a lower end of the curtain body 2 is connected to the lower pull rod 4. The pull rope 3 runs through the upper mounting portion 1, the curtain body 2 and the lower pull rod 4. The lower end of the curtain body 2 and the lower pull rod 4 slide up and down along the pull rope 3. The rope clamp 5 is disposed on the lower pull rod 4 to tightly clamp the pull rope 3 and hence limit the lower pull rod 4. Limiting the lower pull rod 4 refers to that the rope clamp 5 is fixedly fitted to the lower pull rod 4. The rope clamp 5 can clamp the pull rope 3, such that the rope clamp 5 can stay at any position of the pull rope 3 by clamping the pull rope 3 and thus the lower pull rod 4 can stay at any position of the pull rope 3 along with the rope clamp 5. Therefore, the curtain body 2 can stay at any position of the pull rope 3 along with the pull rope 3, thereby opening and closing the curtain body 2 at any position. The rope fixing device 6 is fixedly disposed below the lower pull rod 4 to fix a free end of the pull rope 3 exposed below the lower pull rod 4. In this way, a fixed rope rail of the pull rope 3 can be formed and hence the lower end of the curtain body 2 can be moved within a distance between the upper mounting portion 1 and the rope fixing device 6.

In the present disclosure, with disposal of the rope fixing device 6 below the curtain to fix the free end of the pull rope 3, a user can open or close the curtain with one hand, while the other hand is freed from pulling the pull rope 3. Since an upper end of the pull rope 3 is fixed to the top of a window frame 8 along with the upper mounting portion 1 and the free end of the pull rope 3 is fixed below the window frame 8 via the rope fixing device 6, the pull rope 3 is tensioned to form a fixed rope rail. Thus, the curtain body 2 can slide up and down along the pull rope 3 and the user can push and pull the lower pull rod 4 with single hand to drive the curtain body 2 to slide up and down along the pull rope 3. Further, the lower pull rod 4 can stay at any position of the pull rope 3 by using the rope clamp 5, bringing convenience to use. In addition, the tensioned pull rope 3 will not swing along with wind so as to limit the lower end of the curtain body 2 from freely swinging, and the curtain body 2 has to move up and down along the pull rope 3. Therefore, the curtain body 2 will not scratch the articles around the window frame 8 during the use of the curtain. Furthermore, since the free end of the pull rope 3 is fixed below the window frame 8 by using the rope fixing device 6, the light-blocking area of the curtain body 2 is increased. Originally, the lower end of the curtain body 2 in natural state may retract together with the pull rope 3 toward the upper mounting portion 1 due to the resilience of the curtain body 2. For example, if the lower end of the curtain body 2 is pulled down one meter, the lower end of the curtain body 2 will rebound 0.1 meters once released, which means that the lower end of the curtain body 2 is actually pulled down 0.9 meters. But, in the present disclosure, the free end of the pull rope 3 is fixed by using the rope fixing device 6 and thus the pull rope 3 is tensioned. In this case, when the lower end of the curtain body 2 is pulled down one meter along the pull rope 3, the rope clamp 5 stops at the instantaneous position of the pull rope 3 without any rebound. Therefore, its unfolding area is an area that it is actually pulled open, making the light-blocking area larger and more accurate. After the pull rope 3 is fixed by the rope fixing device 6, the pull rope 3 will not retract upward due to the rebound of the curtain body 2. Overcoming the resilience of the curtain body 2, the pull rope 3 enables the curtain body 2 to stop at any instantaneous position, bringing better use experiences. Furthermore, after the free end of the pull rope 3 is fixed, the children will be prevented from playing with the pull rope, reducing the safety problems.

As a preferred embodiment, as shown in FIG. 1, there is one pull rope 3, one rope clamp 5 and one rope fixing device 6. The pull rope 3 runs through the upper mounting portion 1, the curtain body 2 and the lower pull rod 4 to form a rectangle. Both ends of the pull rope 3 run through the rope clamp 5 and are fixed by the rope fixing device 6. The rope clamp 5 is fixed at a middle position of the lower pull rod 4, and the rope fixing device 6 is fixed exactly below the rope clamp 5. During use, the user can push and pull the lower pull rod 4 with single hand to open and close the curtain body 2.

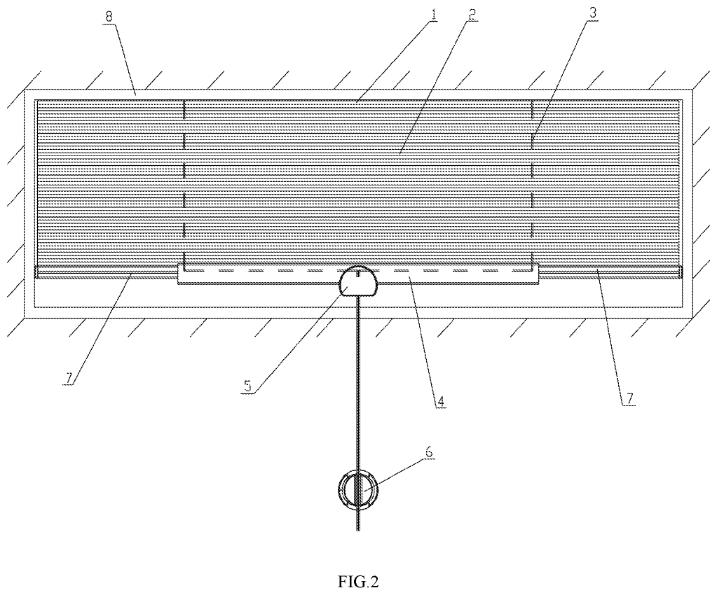

As another preferred embodiment, as shown in FIG. 2, there are two pull ropes 3, one rope clamp 5 and one rope fixing device 6. The two pull ropes 3 run through the upper mounting portion 1, the curtain body 2 and the lower pull rod 4 in a left-right symmetric way. The upper ends of the two pull ropes 3 are fixed to the upper mounting portion 1, and the lower ends of the two pull ropes 3 both run through the rope clamp 5 and are fixed by the rope fixing device 6. The rope clamp 5 is fixed at a middle position of the lower pull rod 4, and the rope fixing device 6 is fixed exactly below the rope clamp 5. During use, the user can push and pull the lower pull rod 4 with single hand to open and close the curtain body 2.

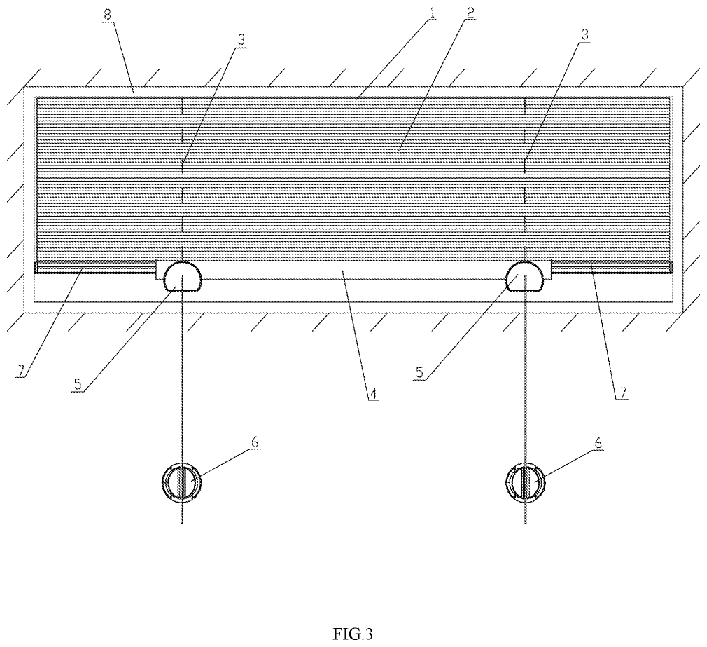

As another preferred embodiment, as shown in FIG. 3, there are two pull ropes 3, two rope clamps 5 and two rope fixing devices 6. The two pull ropes 3 run through the upper mounting portion 1, the curtain body 2 and the lower pull rod 4 in a left-right symmetric way. The upper ends of the two pull ropes 3 are fixed to the upper mounting portion 1, and the lower ends of the two pull ropes 3 both run through the corresponding rope clamps 5 respectively and are fixed by the corresponding rope fixing devices 6. The two rope clamps 5 are symmetrically fixed on the lower pull rod 4, and the two rope fixing devices 6 are fixed exactly below the corresponding rope clamps 5. During use, the user can push and pull the lower pull rod 4 with single hand to open and close the curtain body 2.

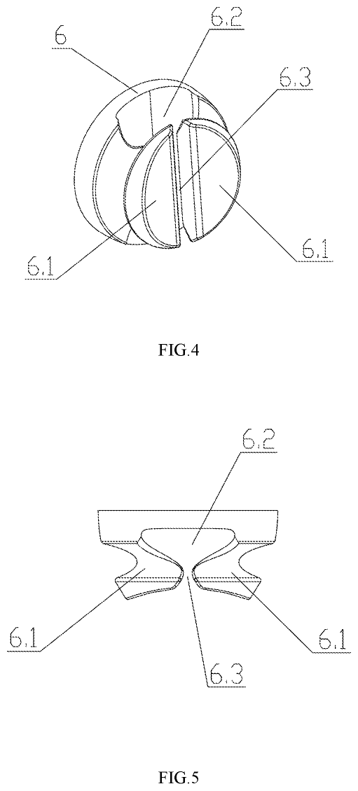

As shown in FIGS. 4 and 5, the rope fixing device 6 is fixed on a wall surface below the window frame 8. Symmetric rope-winding portions 6.1 are disposed on the rope fixing device 6 to wind and receive the free end of the pull rope 3. Specifically, the rope winding can be performed based on a use habit of the user, which is not limited herein. A rope-running groove 6.2 is formed between the rope-winding portions 6.1 on the rope fixing device 6, where a groove mouth 6.3 of the rope-running groove 6.2 has a width less than a diameter of the pull rope 3 so as to further fix the pull rope 3. After the pull rope 3 is wound around the rope-winding portions 6.1, a surplus part of the pull rope 3 can be clamped into the rope-running groove 6.2. The disposal of the groove mouth 6.3 can enable the pull rope 3 to be clamped into the rope-running groove 6.2 under an external force while preventing the pull rope 3 in natural state from slipping out of the rope-running groove 6.2, facilitating rope locking and unlocking.

The upper mounting portion 1 is an adhesive layer which can be cut by an ordinary cutting tool. The adhesive layer, on the one hand, can be easily mounted, for example, can be directly attached to the top of the window frame 8, saving time and labor, and on the other hand, the adhesive layer can also be cut easily together with the curtain body 2 to adapt to various sizes of window frames 8. The user can freely determine a cutting length without taking trouble to determine a size of a curtain, thereby reducing the selection difficulties. During use, it is only required to tear off a protective film on the adhesive layer and attach the adhesive layer to a mounting position and flatten it.

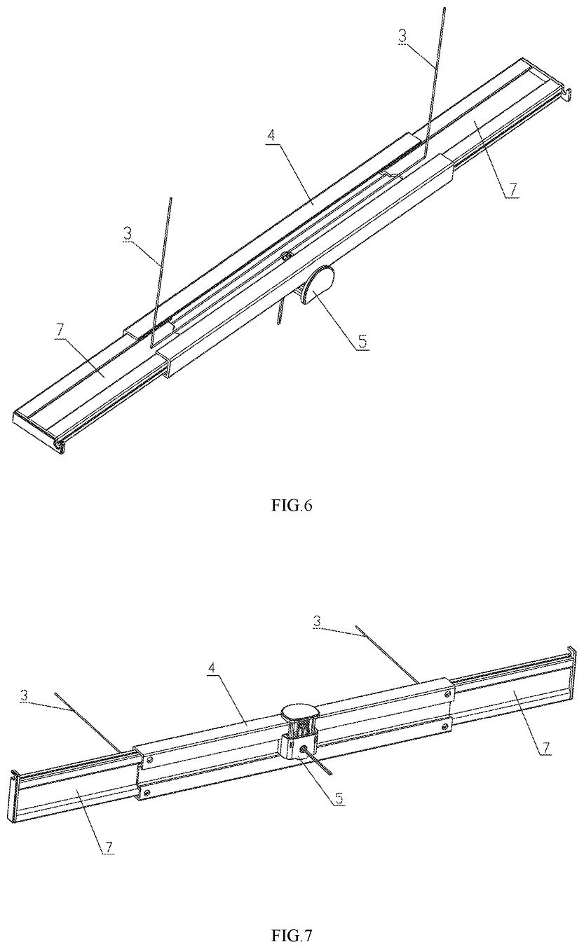

As shown in FIGS. 6 and 7, auxiliary rods 7 are symmetrically and slidably connected at both ends of the lower pull rod 4 to adapt to different sizes of window frames 8. The curtain body 2 and the upper mounting portion 1 are easy to cut because of being made of flexible material, and the lower pull rod 4 is usually made of metal material which cannot be easily cut by an ordinary tool. Therefore, in order to help the user to adapt the lower pull rod to various sizes of window frames 8, the auxiliary rods 7 may be added to adjust the lower pull rod 4 based on different sizes of window frames 8. When the curtain body 2 and the upper mounting portion 1 are cut to adapt to the width of the window frame 8, the auxiliary rods 7 may be retracted into the lower pull rod 4 to adapt to the width of the curtain body 2, eliminating the need of cutting the lower pull rod 4. When the length of the lower pull rod 4 itself is less than the width of the curtain body 2, the auxiliary rods can be adjusted in such a way that a combination length of the lower pull rod 4 and the auxiliary rods 7 is equal to the length of the curtain body 2, bringing conveniences to adjustment and use, and achieving wider application scope. The auxiliary rods 7 retract or extend symmetrically at both ends of the lower pull rod 4. The auxiliary rods 7 can be sleeved outside the lower pull rod 4 or into the lower pull rod 4, as long as the purpose of adjusting the length by sliding can be achieved.

As shown in FIGS. 8 to 12, the rope clamp 5 comprises a mounting seat 5.1, a squeeze piece 5.2, and an elastic piece 5.3. The mounting seat 5.1 is embedded onto the lower pull rod 4. The squeeze piece 5.2 is provided with opposed first end 5.2.1 and second end 5.2.2. The first end 5.2.1 of the squeeze piece 5.2 is slidably connected inside the mounting seat 5.1. A first chamber 5.1.2 for slidably connecting the squeeze piece 5.2 is disposed inside the mounting seat 5.1, and the second end 5.2.2 of the squeeze piece 5.2 is exposed outside the mounting seat 5.1. The elastic piece 5.3 is disposed inside the first chamber 5.1.2. One end of the elastic piece 5.3 is abutted against the mounting seat 5.1 and the other end is abutted against the first end 5.2.1 of the squeeze piece 5.2. A first rope-running hole 5.1.1 is disposed on the mounting seat 5.1, and a second rope-running hole 5.2.3 is disposed on the squeeze piece 5.2. In natural state, the elastic piece 5.3 squeezes the mounting seat 5.1 and the squeeze piece 5.2 in opposite directions, such that the first rope-running hole 5.1.1 and the second rope-running hole 5.2.3 are staggered to clamp the pull rope 3. The second end 5.2.2 of the squeeze piece 5.2 is provided with a force receiving surface 5.2.4 for a finger to press. When a finger presses the force receiving surface 5.2.4, the elastic piece 5.3 is compressed, such that the first rope-running hole 5.1.1 and the second rope-running hole 5.2.3 are overlapped to unlock the pull rope 3. The opening direction of the first chamber 5.1.2 is perpendicular to the length direction of the lower pull rod 4, and is same as the width direction of the lower pull rod 4. The force receiving surface 5.2.4 on the squeeze piece 5.2 is exposed outside the lower pull rod 4 to increase an exposed contact area. The force receiving surface 5.2.4 and the squeeze piece 5.2 are integrally formed. The force receiving surface 5.2.4 is an arc surface with its middle being low and both sides high, which adapts to the shape of a finger with its middle being convex. In this case, the shape is more compliant with ergonomic design such that the user can press it more comfortably to unlock the rope clamp 5. Thus, the rope clamp 5 can be slid with less wear along the pull rope 3, extending its service life. When the user pushes or pulls the lower pull rod 4 with single hand, the user can press the force receiving surface 5.2.4 with his thumb to unlock the rope clamp 5 while pushing or pulling the lower pull rod 4 to slide along the pull rope 3. During slide process, there is no friction between the rope clamp 5 and the pull rope 3, and thus, the service lives of the pull rope 3 and the rope clamp 5 can be extended.

The first rope-running hole 5.1.1 is in communication with the first chamber 5.1.2. Further, at least two first rope-running holes 5.1.1 are disposed, which are respectively located on the top and the bottom of the first chamber 5.1.2 and opposed to each other up and down. The squeeze piece 5.2 is slidably connected inside the first chamber 5.1.2 and the second rope-running hole 5.2.3 on the squeeze piece 5.2 is correspondingly located between the up and lower first rope-running holes 5.1.1. With the elastic slide of the squeeze piece 5.2, the second rope-running hole 5.2.3 is staggered or overlapped with the corresponding two first rope-running holes 5.1.1, so as to clamp or unlock the pull rope 3 running through the first rope-running holes 5.1.1 and the second rope-running hole 5.2.3. At least one pull rope 3 may be run through the first rope-running holes 5.1.1 and the second rope-running hole 5.2.3. In a case of multiple pull ropes 3, two or more groups of the above first rope-running holes 5.1.1 and second rope-running hole 5.2.3 may be set.

A second chamber 5.1.3 for mounting the elastic piece 5.3 is formed in the first chamber 5.1.2. The first end 5.2.1 of the squeeze piece 5.2 is provided with a protrusion column 5.2.5 for connecting the elastic piece 5.3. With cooperation of the second chamber 5.1.3 and the protrusion column 5.2.5, both ends of the elastic piece 5.3 can be positioned respectively to achieve a limiting effect, preventing the elastic piece 5.3 in operation from slipping elastically. When the tip of the first end 5.2.1 of the squeeze piece 5.2 is abutted against an opening end of the second chamber 5.1.3, the first rope-running holes 5.1.1 are overlapped with the second rope-running hole 5.2.3 such that the user can achieve unlocking effect without considering the distance of pressing the squeeze piece 5.2.

Stop blocks 5.1.4 are symmetrically disposed at both sides of an opening end of the first chamber 5.1.2. Catching blocks 5.2.6 matching the stop blocks 5.1.4 are disposed at both sides of the first end 5.2.1 of the squeeze piece 5.2. In natural state, the catching blocks 5.2.6 are abutted against the stop blocks 5.1.4, and the first rope-running holes 5.1.1 are staggered with the second rope-running hole 5.2.3. The catching blocks 5.2.6 and the stop blocks 5.1.4 cooperate to achieve a limiting effect to prevent the squeeze piece 5.2 from being pushed out of the first chamber 5.1.2 by the elastic piece 5.3. A surface of the stop blocks 5.1.4 facing toward outside is an inclined surface, and a surface of the catching blocks 5.2.6 facing toward the first end 5.2.1 of the squeeze piece 5.2 is also an inclined surface, such that when the squeeze piece 5.2 is inserted into the first chamber 5.1.2, the cooperation of both of the inclined surfaces can achieve guide effect, facilitating smooth insertion of the squeeze piece 5.2, improving the assembling efficiency and stopping the reverse slip. A partition groove 5.2.7 is disposed between the second rope-running hole 5.2.3 and the catching blocks 5.2.6 and located close to the first end 5.2.1 on the squeeze piece 5.2; and positioning ribs 5.1.5 cooperating with the partition grooves 5.2.7 are disposed in the first chamber 5.1.2. Due to the disposal of the partition grooves 5.2.7, the squeeze piece 5.2 can be more easily inserted into the first chamber 5.1.2. When the squeeze piece 5.2 is inserted into the opening of the first chamber 5.1.2, the catching blocks 5.2.6 can squeeze the stop blocks 5.1.4. With the presence of the partition grooves 5.2.7, parts with the catching blocks 5.2.6 on the squeeze piece 5.2 may bend to deform, such that the catching blocks 5.2.6 at both sides run toward the middle of the squeeze piece 5.2 to avoid the stop blocks 5.1.4, and thus the squeeze piece 5.2 can be smoothly inserted into the first chamber 5.1.2. In addition, the positioning ribs 5.1.5 can exactly fill the space of the partition grooves 5.2.7, that is, the positioning ribs 5.1.5 can be inserted into the partition grooves 5.2.7 to achieve a filling effect and prevent the partition grooves 5.2.7 from failing to reset due to deformation during use. The positioning ribs 5.1.5 are filled into the partition grooves 5.2.7 to prevent the deformation of the partition grooves 5.2.7, and also limit the squeeze piece 5.2 from extending excessively into the first chamber 5.1.2 due to an external force. The elastic piece 5.3 is preferably a spring or elastic sheet.

During mounting process, people may freely cut the curtain body 2 and the adhesive layer based on the size of the window frame 8. The curtain body 2 is mainly a honeycomb curtain body or a shutter curtain body, which is easy to cut. Then, the auxiliary rods 7 slidably connected at both ends of the lower pull rod 4 are adjusted to be flush with both ends of the curtain body 2. Then, the adhesive layer at the top of the curtain body 2 is attached to the top of the window frame 8 and the rope fixing device 6 is bonded to a wall surface below the window frame 8, and then the free end of the naturally-drooping pull rope 3 is straightened. Then, a surplus part of the pull rope 3 exceeding the position of the rope fixing device 6 is wound around the rope fixing device 6 and fixed, so as to complete the mounting process. The mounting process can be completed with less time and less labor and the length can be adjusted freely to adapt to various sizes of window frames 8, leading to wider application scope. When the curtain is opened or closed, the user may hold the lower pull rod 4 with single hand while the thumb presses on the force receiving surface 5.2.4 of the rope clamp 5 to unlock the rope clamp, and then, push or pull the lower pull rod 4 to slide along the pull rope 3, so as to open or close the curtain. In this way, operation can be easily performed with single hand while the other hand is freed. Furthermore, in the slide process, friction between the rope clamp 5 and the pull rope 3 may be reduced, and the wear of them may also be reduced, and thus the service life can be extended. When the lower pull rod 4 is released, the rope clamp 5 clamps the pull rope 3 such that the lower pull rod 4 can stay at the instantaneous position and will not offset due to rebound of the curtain body 2. This is because the pull rope 3 is entirely fixed and the rope clamp 5 can overcome the rebound of the curtain body 2 by clamping on the pull rope 3. Furthermore, the curtain body 2 can be pulled down to a position where the lower pull rod 4 is abutted against the rope fixing device 6, increasing the entire light-blocking area. Further, since the pull rope 3 is entirely fixed and the curtain body 2 has to slide along the pull rope 3, the lower end of the curtain body 2 will not swing along with wind, avoiding scratching the area round the window frame 8 and reducing collisions.

The materials, reagents, and test instruments involved in the embodiments of the present disclosure are all commercially-available products in the curtain field unless otherwise stated.

Finally, it is to be pointed out that the above embodiments are merely used to describe the technical solution of the present disclosure rather than limit the present disclosure. Although detailed descriptions are made to the present disclosure by referring to the preceding embodiments, those skilled in the art should understand that the technical solutions recorded in the above embodiments may be modified or part of technical features thereof may be equivalently substituted. Such modifications or substitutions will not cause the essences of the corresponding technical solutions to depart from the spirits and scopes of the technical solutions of various embodiments of the present disclosure.

1. A simply-mounted rope-running curtain, wherein the curtain comprises an upper mounting portion, a curtain body, at least one pull rope, a lower pull rod, at least one rope clamp, and at least one rope fixing device; an upper end of the curtain body is connected to the upper mounting portion and a lower end of the curtain body is connected to the lower pull rod; the pull rope runs through the upper mounting portion, the curtain body and the lower pull rod; the lower end of the curtain body and the lower pull rod slide up and down along the pull rope; the rope clamp is disposed on the lower pull rod to tightly clamp the pull rope and limit the lower pull rod; the rope fixing device is fixedly disposed below the lower pull rod to fix the free end of the pull rope exposed below the lower pull rod.

2. The simply-mounted rope-running curtain of claim 1, wherein there is one pull rope, one rope clamp and one rope fixing device; the pull rope runs through the upper mounting portion, the curtain body and the lower pull rod to form a rectangle; both ends of the pull rope run through the rope clamp and are fixed by the rope fixing device; the rope clamp is fixed at a middle position of the lower pull rod, and the rope fixing device is fixed exactly below the rope clamp.

3. The simply-mounted rope-running curtain of claim 1, wherein there are two pull ropes, one rope clamp, and one rope fixing device; the two pull ropes run through the upper mounting portion, the curtain body and the lower pull rod in a left-right symmetric way; the upper ends of the two pull ropes are fixed to the upper mounting portion, and the lower ends of the two pull ropes both run through the rope clamp and are fixed by the rope fixing device; the rope clamp is fixed at a middle position of the lower pull rod, and the rope fixing device is fixed exactly below the rope clamp.

4. The simply-mounted rope-running curtain of claim 1, wherein there are two pull ropes, two rope clamps and two rope fixing devices; the two pull ropes run through the upper mounting portion, the curtain body and the lower pull rod in a left-right symmetric way; the upper ends of the two pull ropes are fixed to the upper mounting portion, and the lower ends of the two pull ropes both run through the corresponding rope clamps respectively and are fixed by the corresponding rope fixing devices; the two rope clamps are symmetrically fixed on the lower pull rod, and the two rope fixing devices are fixed exactly below the corresponding rope clamps.

5. The simply-mounted rope-running curtain of claim 1, wherein the rope fixing device is fixed a wall surface below the window frame, and symmetrical rope-winding portions are disposed on the rope fixing device.

6. The simply-mounted rope-running curtain of claim 5, wherein a rope-running groove is formed between the rope-winding portions on the rope fixing device, and a width of a groove mouth of the rope-winding groove is less than a diameter of the pull rope.

7. The simply-mounted rope-running curtain of claim 1, wherein the upper mounting portion is an adhesive layer.

8. The simply-mounted rope-running curtain of claim 1, wherein auxiliary rods are slidably connected at both ends of the lower pull rod.

9. The simply-mounted rope-running curtain of claim 1, wherein the rope clamp comprises a mounting seat, a squeeze piece, and an elastic piece; the mounting seat is embedded onto the lower pull rod; the squeeze piece is provided with opposed first end and second end; the first end of the squeeze piece is slidably connected inside the mounting seat; a first chamber for slidably connecting the squeeze piece is disposed inside the mounting seat, and the second end of the squeeze piece is exposed outside the mounting seat; the elastic piece is disposed inside the first chamber; one end of the elastic piece is abutted against the mounting seat and the other end is abutted against the first end of the squeeze piece; a first rope-running hole is disposed on the mounting seat, and a second rope-running hole is disposed on the squeeze piece; the elastic piece squeezes the mounting seat and the squeeze piece in opposite directions in natural state, and the first rope-running hole and the second rope-running hole are staggered to clamp the pull rope; the second end of the squeeze piece is provided with a force receiving surface for a finger to press; when a finger presses the force receiving surface, the elastic piece is compressed, and the first rope-running hole and the second rope-running hole are overlapped to unlock the pull rope.

10. The simply-mounted rope-running curtain of claim 9, wherein the opening direction of the first chamber is perpendicular to the length direction of the lower pull rod, and is same as the width direction of the lower pull rod; the force receiving surface on the squeeze piece is exposed outside the lower pull rod; stop blocks are symmetrically disposed at both sides of an opening end of the first chamber; catching blocks matching the stop blocks are disposed at both sides of the first end of the squeeze piece.
